(19) United States
(12) Patent Application Publication
(10) Pub. No.: US 2026/0233477 A1
(43) Pub. Date: Aug. 13, 2026

(54) MANUFACTURING INSTALLATION FOR BELT AND/OR CARCASS BAND IN THE TIRE INDUSTRY, AND METHOD FOR OPERATING SUCH A MANUFACTURING INSTALLATION

(71) Applicant: Fischer TireTech Germany GmbH, Burgkunstadt (DE)

(72) Inventors: Stefan LINDNER, Kulmbach (DE); Frank SCHMIDT, Thurnau (DE)

(21) Appl. No.: 19/453,938

(22) Filed: Jan. 20, 2026

(30) Foreign Application Priority Data
Feb. 13, 2025 (DE) 10 2025 105 489.4

(51) Int. Cl. B29D 30/00; B29D 30/38; B29D 30/46

(52) U.S. Cl. CPC B29D 30/0061; B29D 30/38; B29D 2030/385; B29D 2030/466

(57) ABSTRACT

A manufacturing installation for belt and/or carcass band in the tire industry, including multiple material-machining manufacturing components able to be controlled based on operating parameters, a control device for controlling the manufacturing components and an operating device. The control device has a storage in which at least one fixed base set of settable operating parameters of the manufacturing components is stored, and is designed to select the base set for control purposes based on at least one user input on the operating device and/or automatically. The control device is furthermore designed to store, in addition to the base set, at least one changeable learning set of settable operating parameters that is determined in a learning process and that is able to be selected for control purposes based on at least one user input on the operating device and/or automatically.

### CROSS-REFERENCE TO RELATED APPLICATIONS

The present application claims priority of DE 10 2025 105 489.4, filed Feb. 13, 2025, the priority of this application is hereby claimed, and this application is incorporated herein by reference.

### BACKGROUND OF THE INVENTION

The invention relates to a manufacturing installation for belt and/or carcass band in the tire industry, comprising multiple material-machining manufacturing components able to be controlled based on operating parameters, a control device for controlling the manufacturing components and an operating device, wherein the control device has a storage means in which at least one fixed base set of settable operating parameters of the manufacturing components is stored, and is designed to select the base set for control purposes based on at least one user input on the operating device and/or automatically. The invention also relates to a method for operating such a manufacturing installation.

Manufacturing installations in which a starting band, in particular a tacky cord band, is processed into an endless band as a manufacturing product, which is used as belt band or carcass band in the tire industry, are generally known in the prior art. Depending on the intended use, they may also be referred to as a belt installation or carcass installation. The manufacturing installation may also be understood generally as a machine or device for processing a cord band in the tire industry. Band sections are severed from the starting band, in particular the tacky cord band, be this a textile cord band or a steel cord band, and an endless band is manufactured by splicing. The starting band is usually wound into a roll and received in an unwinding station, from which it is unwound and initially supplied to scissors, that is to say a cutting device, in which individual band sections are cut from the starting band. Such a cutting device is known for example from DE 20 2013 103 082 U1. The leading edge of the starting band is detected using a conveying device designed as a retraction device, such as pliers for example, and pulled by the cutting apparatus, for example guillotine scissors comprising a fixed lower blade and a movable upper blade, wherein the width of the band section to be cut is defined by the pulling length. Such a conveying device, or pliers, is described for example in DE 20 2013 102 341 U1. The cut band section is received by a conveyor belt as a further conveying device, via which the starting band is pulled before being cut by way of the retraction device, that is to say the pliers, and via which conveyor belt the respectively cut band section is transported to a splicing device, in which the cut band sections are spliced together to form an endless band, but with a different orientation compared to the starting band. In the splicing device, the trailing edge of the band section previously spliced to the endless band and the leading edge of the band section conveyed by the conveyor belt are positioned in relation to one another, after which the two edges are spliced together by way of a splicing apparatus of the splicing device. The splicing apparatus for this purpose has for example a splicing tool, which may comprise one splicing head or multiple splicing heads. The splicing head or splicing heads are in this case fed from above to the previously positioned edges. Following the respective placement of the splicing heads, pulling is carried out linearly along the splicing line, in the pressed state, over the band material in the direction of the lateral band edges over the band material. The splicing heads may run loose or be driven. During pulling over the band material, the latter is compacted and thus spliced. It is thereby possible to produce an endless band by splicing together a large number of individual band sections. Such a splicing device is known for example from DE 20 2014 101 735 U1.

In a winding station, the manufacturing product may then be wound up, wherein, downstream of the splicing device, further manufacturing components may optionally be provided in order to process the spliced-together endless band. By way of example, the manufacturing installation may comprise a slitter and/or a covering apparatus. A rubberized band may be applied to the cord band as a spliced-together endless band in a covering apparatus. Such a covering station has the task of reinforcing the produced material web, in this case the spliced-together cord band, during the manufacturing process with additional material strips. In this case, rubber profile strips are applied centrally and/or with an offset to the material web to be reinforced in the material conveying direction. This process runs continuously at the speed of the installation. The application may be carried out from above and/or from below. Furthermore, the outer edges of the material web are often edged, that is to say a rubber strip is applied from the outer edge with an overhang and laid around the rubber edge in order to cover the cord threads exposed at the outer edge (= cutting edge). A covering apparatus is disclosed by way of example by DE 20 2014 101 731 U1.

The slitter manufacturing component is a longitudinal cutting apparatus, that is to say the material web, in this case the spliced-together endless band, is separated into at least two material strips in the production process if required. It is used to increase the output of a manufacturing installation. Circular blades are usually used as slitter blades. The separation process is cutting of the material web. In practice, the term “slitting” is used. The slitter manufacturing component is designed to separate a supplied endless band into at least two or more band strips. The material web is cut here into defined material widths, which yield the same or different band strips. Slitters are described for example in DE 20 2013 104 649 U1, DE 20 2013 104 651 U1 and DE 20 2013 104 653 U1.

The description of a manufacturing product that is to be manufactured in a manufacturing process by way of such a manufacturing installation is specified by an operating parameter set of operating parameters that are unchangeable for this manufacturing process, which is usually referred to as a recipe or MES. In addition to a general recipe identification (recipe ID), a recipe may for example comprise the cutting angle to be applied in the scissors and the desired width of the material webs obtained as belt band or carcass band. The recipe may also describe a type of starting band to be used. A recipe is thus described mainly by the requirements placed on the manufacturing product, and is independent of the specific manufacturing installation. However, it may contain requirements placed on manufacturing speed and/or output, that is to say the quantity produced per unit of time.

The quality of the obtained manufacturing product, thus in this case of the endless belt band or endless carcass band, is, as has been shown, dependent on a multiplicity of factors. First of all, each manufacturing installation is individual. Settable operating parameters, used for a recipe for the specific control of the manufacturing components, are often supplied by the manufacturer in a base set of operating parameters, in particular on a recipe-specific basis. They allow the belt or carcass band to be manufactured within sufficient tolerances, but not in a completely optimal manner. In other words, the operating parameters of the base set, that is to say default parameters, are provided by the manufacturer and ensure that the process runs smoothly and delivers acceptable quality. For various recipes, improvement or optimization is carried out for example by the operator, who may make adjustments based on the operating parameters of the base set through “trial and error” or based on in-depth knowledge of the manufacturing installation. However, such employees with enormous experience in specific manufacturing installations and the corresponding know-how are becoming increasingly rare. It has already been suggested to use closed control loops for individual subprocesses, but these cannot take into account the overall context of the manufacturing installation.

It has also been shown that, especially in the manufacture of endless bands for carcasses or belts in the tire industry, other potentially changeable manufacturing conditions may also have a strong influence on the quality of the manufacturing product. By way of example, changes of material and/or in the ambient temperature may have non-negligible influences, which may lead for example, following a material change, to the need for a lengthy, strenuous and complex optimization process in order to (re)find the appropriate values for the settable operating parameters. The working properties of the slitter are for example extremely material-dependent, and materials may change frequently. This is a dynamic process in which cutting is carried out longitudinally, in particular using at least one circular blade, and so the angle at which the material web arrives, and whether a thin/thick material is involved and the like, are highly relevant.

In summary, it may thus be said that the optimization in terms of manufacturing conditions and the quality of the manufacturing product in the manufacture of belt and carcass bands in the tire industry is carried out through visual observation, logging and mechanical fine-tuning performed by the operator. A machine shutdown is required for an inspection. It is difficult to accurately manually record properties and operating parameters during the manufacturing process. Since early recognition of deviations during the manufacturing process is not possible, or is possible only to a limited extent, and fine adjustments of settable operating parameters may also be necessary at the start of a manufacturing process, increased scrap production may occur.

### SUMMARY OF THE INVENTION

The invention is therefore based on the object of specifying a manufacturing installation for belt and carcass band in the tire industry that is improved in relation thereto, in particular that simplifies handling, reduces operating errors, improves product quality and/or reduces the quantity of scrap produced.

In order to achieve this object, provision is made, in the case of a manufacturing installation of the type mentioned at the outset, for the control device to furthermore be designed to store, in the storage means, in addition to the base set, at least one changeable learning set of settable operating parameters that is determined in a learning process and that is able to be selected for control purposes based on at least one user input on the operating device and/or automatically.

The attribute “settable” for operating parameters is understood here to mean that the value of the operating parameter may be changed during the manufacturing process of a specific manufacturing product, that is to say an endless belt band or endless carcass band, able to be described by default parameters. These are in particular operating parameters that are able to be set within what is known as a recipe. A recipe basically comprises operating parameters that are independent of the specific manufacturing installation, which at least describe the manufacturing product (that is to say comprise the default parameters) and may optionally additionally describe manufacturing conditions, for example a desired output. Typical default parameters may comprise for example a width of the manufacturing product, a general material specification and/or a cutting angle of the scissors (cutting device). Some of the operating parameters of a recipe may also be combined as a recipe ID.

Operating parameters that define the recipe or would change it if changed cannot be modified during the manufacturing process for the manufacturing product, that is to say the implementation of the recipe. The operating parameters of the recipe are provided, for example in a recipe dataset, at the start of the manufacturing process, for example loaded and/or entered from a data carrier and/or server. The operating parameters of a recipe, or generally operating parameters that cannot be changed during a manufacturing process, may be understood to be (some of the) manufacturing conditions or describe same.

A settable operating parameter does not directly have to be a control parameter (for example to be converted into control signals). On the contrary, more abstract settable operating parameters are also conceivable, from which the control device derives at least one, possibly also multiple, control parameters. In particular, the more abstract settable operating parameter may be more intuitively comprehensible to the operator, for example specify a correction that is then achieved specifically by one or more control parameters. In some cases, the more abstract settable operating parameter and the control parameters may also both be able to be stored as settable operating parameters or at least able to be output via an output means.

According to the invention, superordinate control thus provides the possibility of retaining learning results or optimization results, that is to say results of a learning process, in order to call on them again later. This means that the results, that is to say in particular optimized settable operating parameters, are not lost in the event of a change in the recipe and/or other manufacturing conditions, but are stored as at least one learning set in addition to the base set. The base set is therefore also retained in order to retain a reliable starting point at any time, for example in the event of completely new manufacturing conditions. The operator and/or an automatic control logic thereby have both the basis to continue to use results of previous learning processes and the possibility to use the base set that reliably provides acceptable quality.

New manufacturing processes may therefore, if learning results, that is to say operating parameters of a stored learning set, are already present for this purpose (or in at least partially comparable cases), be brought more quickly towards an optimum, in particular by reducing the resulting scrap in a “start-up phase” and/or reducing conceivable operating errors in which operating parameters are adapted unfavorably.

As will be explained in more detail below, the control device may in particular have an intelligence, that is to say be designed such that particularly suitable or optimized settable operating parameters are able to be determined and suggested or set automatically for the upcoming manufacturing process. This also provides excellent support for the operator in general.

The manufacturing installation is designed to determine installation-specific setting values for the settable operating parameters, in particular automatically, during operation (in real time) for a manufacturing process, and in particular to manage them transparently. Learning processes are used to optimize these operating parameters, and their results are further processed on a product-dependent basis. This processing and management saves time for the operator, and product quality is improved.

In particular, the further use of learning and optimization results makes it possible to reduce or even completely avoid interruptions in the operation of the manufacturing installation (that is to say a machine shutdown) for corrective work and possible fine-tuning performed by the operator. The learning sets containing the newly learned operating parameters also allow the manufacturing installation to be changed over to a new manufacturing process, in particular a new recipe, without a long changeover time and with little scrap.

In principle, provision may be made for the learning set to be determined at least partially in a user-guided learning process, in which said user adapts at least one of the settable operating parameters towards an optimum by way of the operating device. For at least some of the settable operating parameters, provision may therefore be made for these to be improved towards an optimum by being successively adjusted by an operator. In this case, not only does the operator thus then learn what effect the adjustments have and how it is possible to achieve improvements in product quality or other benchmarks, but also the control device and the operator or other operators benefit in the future from the result of the learning process by virtue of the set values being stored. Operator experience is thus retained.

In one particularly preferred embodiment of the present invention, provision may be made for the control device to be designed to determine the learning set at least partially in an automatic learning process. In this case, it is thus the manufacturing installation itself that seeks to achieve an optimum in an automatic learning process by way of the appropriately designed control device, as far as at least some of the settable operating parameters are concerned. It is therefore also conceivable within the scope of the present invention to achieve a combination of manually and automatically achieved learning results in the learning set.

The described embodiment may particularly expediently be combined with closed-loop control. Provision may therefore be made for the control device to comprise a closed control loop for at least one controllable one of the settable operating parameters, wherein values of the at least one controllable operating parameter for the learning set are determined in an at least quasi-static state of the control loop from the set manipulated values of the at least one controllable operating parameter. A quasi-static state should be understood here to mean that the manipulated value of the at least one controllable operating parameter changes only within a predefined tolerance range within a defined period. The presence of a quasi-static state may be an additional condition, for example when storing the learning set in the event of a recipe change.

In a closed control loop, which may be implemented by a corresponding closed-loop control device, which may be part of the control device or else external thereto, for example, at least one measured variable recorded using sensors and/or otherwise may be evaluated in order to identify a control deviation that is present. By way of example, the measured variable may be compared with a corresponding setpoint (reference variable). A change in the control variable, that is to say the manipulated value of at least one corresponding settable operating parameter, also leads to a change in the measured variable, and so an updated manipulated value may be determined from the control deviation.

Since closed-loop control usually does not lead to an absolutely constant optimum operating point, provision may expediently be made for an average value of the manipulated values within the defined period to be used as the operating parameter value of the at least one controllable operating parameter for the learning set. The defined period may in this case for example be a fixedly predefined interval before a storage time and/or require the presence of an at least quasi-static state.

The closed control loop may be designed to carry out closed-loop control with respect to an optimization objective. The optimization objective may be described for example by at least one setpoint, but also differently, for example by a desired minimization or maximization of an expression. Since there is an optimization objective with respect to which the closed-loop control is carried out, this is understood to be a learning process, since it gets as close as possible to the optimum.

In principle, the base set and the learning set may comprise at least one operating parameter that relates to a specific manufacturing component, for example one at which the closed control loop is present. This in particular also means that one of the at least one learning process to which the learning set relates may also be component-related, in particular including independently of other components. In the case of an automatic learning process that relates to a manufacturing component, component-specific data may thus be evaluated therein and a correction (value or values of at least one settable operating parameter of the manufacturing component) may be made in an application or a manufacturing process with respect to an optimization objective. By being stored in the learning set, the one or more newly determined values of the at least one settable operating parameter of the manufacturing component may be noted and used again in a further manufacturing process.

Particularly advantageously, the settable operating parameters may comprise at least one operating parameter relevant to multiple or all manufacturing components, in particular operating parameters used when controlling the multiple or all manufacturing components. The fact that the control device and in particular the learning set concern the manufacturing installation as a whole is utilized here. There is therefore higher-level control that concerns the manufacturing installation as a whole. Exemplary operating parameters that may be relevant to multiple or even all manufacturing components may describe the conveying speed and/or the output. By way of example, the conveying speed at all manufacturing components must be implemented or taken into consideration in order to ensure a smooth process. On the other hand, this may also depend on properties of the manufacturing components themselves or be limited thereby, for example, in the case of cutting manufacturing components, by their possible cutting speed, for example depending on the material or, in the case of the splicing device, by its splicing speed range. Generally speaking, the control device may be designed, in this context, to link at least one settable, in particular component-related, operating parameter with other installation-specific operating parameters and/or operating parameters specific to other manufacturing components, and vice versa. It goes without saying that higher-level closed-loop control for at least two manufacturing components is also basically conceivable. Furthermore, the control device may be designed, in the event of a change to an operating parameter that takes place in a component-specific learning process, if the operating parameter is also relevant to other manufacturing components, to adjust these operating parameters linked to the changed operating parameter to these other manufacturing components accordingly. This enables a holistic view of a global optimum of the manufacture through higher-level control.

It may be particularly expedient to associate the settable operating parameters of the learning set with manufacturing conditions, in particular a current recipe.

Particularly advantageously, provision may therefore be made for multiple base sets and learning sets for different manufacturing parameters, in particular recipes, to be able to be stored in the storage means and/or for the control device to be designed to retain, in addition to a base set, multiple learning sets assigned to different manufacturing conditions in the storage means for selection. Thus, generally speaking, it is possible to store learning sets for a wide variety of manufacturing conditions and select and use them again for control purposes when necessary if these manufacturing conditions occur again. In principle, as already explained, manufacturing conditions may in this case also comprise which recipe is currently being manufactured. In one particularly advantageous embodiment, base sets each containing at least one assigned learning set may each be assigned to a specific recipe. This means that, for (ideally) each recipe, there is a base set and – as soon as storage has taken place – at least one learning set. It is then particularly expedient, since there may also be different manufacturing conditions within a recipe, for each base set to be able to be assigned multiple learning sets for different manufacturing conditions. It is thus possible to learn optimized settable operating parameters for a wide variety of situations and reuse them in comparable situations, in particular for comparable manufacturing processes, which significantly enhances the advantages in terms of product quality, avoidance of scrap, rapid adjustment to a new manufacturing process and user-friendliness.

The manufacturing conditions may be detected automatically at least partially by the control device, for example by way of at least one sensor. However, detection or derivation from condition information provided by the user is also conceivable, for example with regard to the recipe to be performed, the material used and the like. The control device may in particular be designed to store the manufacturing conditions as a condition dataset assigned to the learning set.

Expediently, the control device may be designed to select one of the learning sets for current manufacturing conditions based on a comparison result of the manufacturing conditions of the learning sets with the current manufacturing conditions. The control device may in this case perform the comparison in particular automatically at the start of a new manufacturing process, which may be subject to new manufacturing conditions, for example due to a new recipe. This is also conceivable on request by an operator and/or in the event of an identified, in particular significant change in the manufacturing conditions during a manufacturing process. While an at least approximately complete match between the manufacturing conditions is ideal, it is also conceivable to use operating parameters of a learning set in the case of manufacturing conditions that do not match completely or that match only partially. By way of example, a hierarchical check is conceivable in which, in the case of a recipe, the recipe ID, the desired width and the desired cutting angle should ideally match, wherein, if this is not possible, for example, it may also be considered to be sufficient if the recipe ID and cutting angle match, or it may even be sufficient if the recipe ID matches. At least a partial transfer of learned knowledge is thus possible.

Provision may also be made for the comparison to be carried out on an at least partially component-related basis. By way of example, the base set and the at least one learning set may also comprise subsets relating to at least one manufacturing component, which subsets are then separated or able to be applied alone if the component-related comparison indicates a sufficient match. Provision may be made in particular for at least some of the operating parameters to be assigned relevant manufacturing conditions, wherein individual operating parameters of a learning set may also be selected for setting purposes if the comparison result indicates a match with regard to the relevant manufacturing conditions. This makes it possible to derive optimum technical benefit from stored operating parameters of the learning sets.

The selection may preferably, at least in an automatic mode, also result in automatic use, therefore setting of the operating parameters of the learning set (or at least some of the operating parameters of the learning set). This means that the control device, at least in an automatic operating mode, may be designed, following selection of at least one of the at least one learning set, to use the learning set to control the manufacturing components, which will be discussed in more detail below.

It is also particularly expedient for the control device, in the event of an in particular user-controlled change to the manufacturing conditions, in particular the selection of a new recipe at the start of a new manufacturing process, to be designed to store the current operating parameters as a learning set assigned to the previous manufacturing conditions. The automatic storage may be linked to additional conditions, for example again the presence of the automatic mode, the presence of confirmation by an operator, a deviation from a previous learning set assigned to the same manufacturing conditions and/or, in the case of an automatic learning process, the presence of an at least quasi-static state. Each time the operating conditions change, that is to say in particular in the event of a transition to a new manufacturing process, everything learned to that point is thus retained, in particular automatically. Experience is thus preserved in order to enable an improvement in efficiency and product quality in the future.

Generally speaking, provision may be made for the control device to be able to be designed to be operated in multiple operating modes, wherein an operating mode to be used is able to be selected by way of the operating device. One of the operating modes may be a or the automatic operating mode, in which the control device automatically selects a learning set or base set and in particular also automatically sets it for use, therefore controls the manufacturing installation in accordance with the corresponding operating parameter set. One of the operating modes may accordingly be a manual mode, in which the user input is used, but this may also lead to the automatic use of the operating parameter set selected by the user input, that is to say of the base set or one of the at least one learning set.

In one preferred development, provision may be made, in the presence of one of the stored learning sets and settable current values for at least one variable one of the operating parameters that deviates from the learning set, in particular at least due to the control loop, for the control device to be designed to determine deviation information, indicating the deviation of the current values of the operating parameters from those of the learning set, and to evaluate the deviation information using at least one measure condition, wherein the control device is designed to perform a measure assigned to a fulfilled one of the at least one measure conditions. The control device may therefore also make further use of the empirical values described by the learning sets and automatically evaluate them in order to be able to better assess current manufacturing situations. This applies in particular to operating parameters able to be adjusted by the control device itself, therefore automatically, but may also apply to operating parameters set by an operator, wherein the meaningfulness of the values may be checked using values of the operating parameters in learning sets as a reference by way of example. In other words, and generally speaking, the control device may therefore be designed to use learning sets stored in the storage means when monitoring manufacturing processes, in particular in order to identify and assess deviations, trends and the like. It is thereby also possible to identify anomalies. The reference that is used, that is to say the at least one of the multiple learning sets used to determine the deviation information, may be selected here in such a way for example that there is the greatest possible match with regard to the manufacturing conditions. A prioritization of manufacturing conditions may be used here.

Specifically, at least one of the at least one measure may concern the output of a warning and/or alarm to an operator and/or the scheduling of predictive maintenance and/or at least one of the at least one measure may concern storage of the current values of the operating parameters as a learning set. In the event for example of identifying a significant deviation in at least one settable operating parameter with otherwise identical manufacturing conditions or different manufacturing conditions that are not relevant to this operating parameter, an operator may be made aware of this inconsistency and take appropriate measures in timely fashion also to continue to ensure the manufacture of a high-quality product. Trends, for example drifting values of operating parameters, may provide early indications of any maintenance that may be required. An operator may also be made aware thereof accordingly. This improves the functionality of the manufacturing installation and reduces failures due to wear-induced damage. Warnings, alarms and maintenance indications may be output via the operating device, for example an output means of the operating device; however, it is also conceivable, in the case of a communication connection between the manufacturing installations or at least the control device, for example to the Internet, as is often the case, to use other communication channels for the output to the operator, for example e-mails, mobile telephones (for example apps installed thereon) and the like.

In the case of a storage-related measure, the control device may be designed

in the event of current manufacturing conditions that are able to be determined and that deviate from those when determining the learning set used for the comparison, to store the learning set to be stored in a manner assigned to these current manufacturing conditions, and/or

in the event of current manufacturing conditions that are able to be determined and that do not deviate from those when determining the learning set used for the comparison (or deviate only slightly, within a tolerance), to replace the learning set used for the comparison.

The control device may thus make an intelligent decision as to whether and when learning sets should be updated or newly applied.

In particularly preferred exemplary embodiments, provision may be made for the operating device to have an output means, in particular a display, for outputting a user interface, wherein the control device is designed to generate at least one operating parameter display on the user interface, in which the base set, the learning set and the currently set values of the operating parameters are displayed, and to control the output means so as to output the display. As a result, not only are newly learned values, that is to say a new learning set, thus displayed and communicated by way of the installation display system, but the operator is shown all relevant information, in particular in directly comparable fashion, in a clear operating parameter display on the user interface, such that they are also able, in addition to the current status of the manufacturing installation, to compare them with the values of the settable operating parameters according to the base set and at least one test set. If multiple learning sets are assigned to a recipe and/or a base set, the control device may be designed to select the learning set to be displayed in the operating parameter display, for example based on the comparison result with regard to the manufacturing conditions, as has already been described above. The learning set whose assigned manufacturing conditions best match the current manufacturing conditions is then displayed. The control device may also be designed to incorporate deviations of the current manufacturing conditions from the manufacturing conditions of the displayed learning set into the operating parameter display. This means that the operator is also able to be better informed in this regard. Of course, other operating parameters, for example those that cannot be changed during a manufacturing process, may also be rendered to an operator in the operating parameter display. Preferably, the operating parameter display displays at least one recipe currently in use.

In one expedient embodiment, the user input to select the base set and/or the learning set and/or to request storage of current values of the operating parameters as a learning set may describe an interaction with the operating parameter display, wherein the control device is designed in particular to determine the operating parameter display such that this shows the transfer process visually. By way of example, the operating parameter display may therefore comprise operating elements that are able to be touched directly when the output means is designed as a touchscreen and/or able to be selected using a mouse or the like, which bring about storage of a learning set and/or allow the base set and/or the displayed learning set to be selected for setting purposes. It is particularly advantageous here for the transfer process also to be visualized, for example in the form of an arrow that is highlighted or additionally displayed in the operating parameter display, in the case of storage, for example, from the current values of the settable operating parameters to the displayed values of the learning set and/or, in the case of setting, from the displayed values of the base set or learning set, depending on which was selected, to the current values of the settable operating parameters. If, as will be discussed in more detail below, the last predefined initial values of the settable operating parameters (preset values) are also displayed, these may also be the target of such an arrow in the case of setting. By way of example, the setting options may be visualized basically, for example in greyed-out form, wherein, in the case of a corresponding transfer process, the relevant arrow is highlighted, for example in color.

One preferred development of the invention makes provision, in particular in the case of permanent visualization of the transfer process and/or in the case of additional displaying of the initial values of the operating parameters used for a current manufacturing process, for the control device to be designed to display each operating parameter whose current value deviates from the initial value of the operating parameter for the manufacturing process in highlighted form in the operating parameter display, in particular together with the initial value. If an operating parameter changes, for example due to the use of a closed control loop, another intervention made by the control device and/or in a manner brought about by an operator, this may be visualized in clearly discernible fashion for the operator in the operating parameter display, so that their attention, for example in the case of a monitoring activity, is directed intuitively to the operating parameters in which there is a value change that could be relevant. By way of example, it is conceivable to highlight current values that deviate from the initial values, for example in color, preferably together with the initial value itself, so that the deviation is immediately apparent. The initial value may in this case be highlighted in the display of the respective values of the associated set, that is to say the base set or learning set, but additionally or alternatively also in an optional display of the initial values. The latter case is particularly expedient if for example only some of the settable operating parameters have been adopted as initial values from one of the displayed sets and/or an adjustment has additionally been made by the operator. If the transfer process is visualized permanently, it is also possible to dispense with highlighting the associated initial value, since the reference is already present.

The operating parameter display may expediently comprise tabs, able to be selected by way of the operating device, with partial displays, wherein the partial displays are selected from the group comprising a partial display for general and/or important operating parameters and partial displays for at least one manufacturing component in each case. In this case, it is preferable to start initially with the partial display for general and/or important operating parameters, wherein visible and in particular labeled portions of the other tabs may be used to display these by way of the operating device. This may be expedient for improving clarity, especially in the case of a large number of settable operating parameters for which values are stored in the base set and in the learning set. If changes in relation to the initial values are visualized, it may also be expedient to identify tabs whose partial display is not currently being shown, so that the operator is able to select them directly. In addition, a basic information element that indicates settable operating parameters that deviate from the initial value may also be part of the operating parameter display for each partial display. In the partial display for general and/or important operating parameters, the mentioned more abstract settable operating parameters, where used, may preferably also be displayed, while control parameters able to be derived therefrom, which may possibly form self-settable operating parameters, may be contained in further partial displays. The partial displays may thus at least partially contain details about the more general, abstract statement of the general partial display.

As is generally known for generic manufacturing installations for belt band and/or carcass band, the manufacturing installation according to the invention may preferably also make provision for the manufacturing components to comprise

an unwinding station for a starting band, in particular a cord band,

scissors for cutting band sections at a predefined angle and a predefined width from the starting band from the unwinding station,

a retraction device for conveying the starting band through the scissors,

a splicing device, in particular a butt splicer or an overlap splicer, for connecting the band sections cut by the scissors,

at least one winding station for the belt and/or carcass band, and

at least one conveying device.

A scissors stand of the scissors may serve as material support. In addition, the manufacturing installation may comprise at least one optional manufacturing component, for example a steadying roller and/or a repair belt.

One particularly advantageous application of the present invention is when the manufacturing components furthermore comprise a slitter and/or a covering apparatus. As already explained at the outset, for example, when a slitter is present, there is a strong and complex dependence on different manufacturing conditions, which may in particular also influence settable operating parameters that are relevant to multiple manufacturing components. Incorporation into higher-level control, which allows learning results to be retained, in particular including automatically, therefore also offers in particular improved start conditions and adaptability for manufacturing processes with regard to a slitter, allows faster changeover and reduces scrap produced while achieving high quality as quickly as possible.

A realization of the control concept described here has proven to be particularly expedient if, in the case of a slitter as a manufacturing component and the use of a closed control loop for the slitter, the manufacturing installation has at least one width sensor for determining the width of the slitted band strip, from the sensor data of which the control loop determines at least one of its measured variables. Such closed-loop control based on the widths of slitted band strips is known for example from DE 20 2013 104 651 U1 mentioned at the outset, from which a specific implementation may be deduced. Optionally, in this context, a width of the spliced-together endless band and/or the position of its edges at the feed to the slitter may generally be determined as a further measured variable by way of a further width sensor or edge sensor.

One advantageous specific embodiment may for example make provision for the slitter to have a frame, a cutting unit and a control frame able to swivel about an in particular vertically running axis and having guide rollers mounted rotationally thereon, via which the spliced-together endless band to be supplied to the cutting unit is guided, and the control loop is designed to use an operating parameter, which describes the alignment angle of the control frame of the slitter, and/or an operating parameter, which relates to the transverse position of the cutting unit, which is arranged on the frame so as to be linearly movable in a direction perpendicular to the conveying direction of the endless band via a linear guide, as manipulated variables. Such a configuration is described by way of example in abovementioned DE 20 2013 104 651 U1. In that document, the width sensors are provided in particular on the slitter itself and detect the edges of the band strips. However, it may also be expedient for the at least one width sensor to be arranged on a manufacturing component downstream of the slitter, in particular a or the directly downstream covering device, in particular on the infeed side, and/or for the width sensor to be a sensor that completely measures at least one of the slitted webs.

By way of example, a slitter correction value may be used as a more abstract settable operating parameter with respect to such a slitter, from which the alignment angle and/or the transverse position of the cutting unit is able to be derived as a control parameter (and possibly further settable operating parameters). By way of example, the slitter correction value may be a deviation from the desired division into the widths of the band strips. If for example, as is often the case, two band strips of the same width are supposed to be produced, the difference between their widths as determined by way of the at least one width sensor, divided by the number of band strips, may form the slitter correction value. If for example, in the case of two band strips, 201 mm is measured on the left and 199 mm is measured on the right, this gives a slitter correction value of 1 mm (the cutting line must be shifted by this value, which may be done specifically by adjusting the alignment angle and/or the transverse position). In the opposite case (201 mm on the right, 199 mm on the left), this gives a slitter correction value of -1 mm. Such a more abstract operating parameter, able to be set via downstream control parameters by way of the control loop, is intuitively comprehensible to an operator.

In the case of a covering apparatus for applying at least one rubberized band to the cord band as a manufacturing component, this may have a conveying device for the cord band and a second conveying device for the band to be applied, and an application apparatus that is used to apply the band to the cord band, both of which are fed towards one another at approximately the same speed, wherein the band to be applied is able to be placed on the cord band without pressure by the application apparatus, wherein provision is made for a pressure roller downstream of the application apparatus in the conveying direction of the covered cord band and extending perpendicular to the conveying direction and spaced from the conveying device conveying the transport belt by a gap, wherein the gap is smaller than the total thickness of cord band and applied band, and the application apparatus is linearly adjustable in terms of its transverse position, which forms a settable operating parameter, with respect to the conveying direction. This means for example that closed-loop control may be carried out for the application, in particular transverse offset/deflection. Specifically, provision may particularly advantageously be made, when using at least one closed control loop, for one of these at least one control loops to relate to material strip closed-loop control, in which the band to be applied is able to be measured by an optical detection device, in particular a band edge detector, in order to determine at least one measured variable, and the manipulated variable relates to the transverse position of the application apparatus, which is able to be adjusted perpendicular to the conveying direction by way of an adjustment unit. In addition, provision may also be made for the pressure roller to be height-adjustable in order to vary the gap width, which forms a settable operating parameter. Such an embodiment is known for example from DE 20 2014 101 731 U1 already mentioned at the outset, wherein the exemplary embodiments described therein for manufacturing installations are also applicable here.

Basically, in addition or as an alternative, a multiplicity of other closed control loops and/or other control units that enable automatic learning processes of the control device are conceivable, which may result in further advantages in combination with the described higher-level control. By way of example, a sensor system may be provided for the scissors (switching device), which detects the cutting angle, and in this respect may also allow closed-loop control to the desired cutting angle. A multiplicity of very different, more abstract and specific settable operating parameters are additionally conceivable. Purely by way of example, it is mentioned that at least one of the at least one settable operating parameter for storage in the test set may be selected from the group comprising a speed or speed correction for at least one conveying device and/or a positioning of at least one conveying device, in particular a conveyor belt, and/or a position of a splicing head of a splicing apparatus and/or a splicing offset correction and/or a splicing angle correction and/or a splicing time correction and/or a splicing path correction and/or a cutting speed and/or cutting blade speed and/or the activity of at least one additional unit, for example a ventilation unit and/or a pressing unit.

In addition to the manufacturing installation, the present invention also relates to a method for operating a manufacturing installation for belt and/or carcass band in the tire industry, comprising multiple material-machining manufacturing components able to be controlled based on operating parameters, a control device for controlling the manufacturing components and an operating device, wherein the control device has a storage means in which at least one fixed base set of settable operating parameters of the manufacturing components is stored, and the control device is designed to select the base dataset for control purposes based on at least one user input on the operating device and/or automatically. In this case, the control device

stores, in the storage means, in addition to the base set, at least one changeable learning set of settable operating parameters that is determined in a learning process, and

selects at least one of the at least one learning set for control purposes based on at least one user input on the operating device and/or automatically.

All statements with regard to the manufacturing installations according to the invention may be transferred analogously to the method according to the invention, with which the advantages already mentioned may thus be achieved.

The various features of novelty which characterize the invention are pointed out with particularity in the claims annexed to and forming a part of the disclosure. For a better understanding of the invention, its operating advantages, specific objects attained by its use, reference should be had to the drawings and descriptive matter in which there are illustrated and described preferred embodiments of the invention.

### BRIEF DESCRIPTION OF THE DRAWING

### In the drawings:

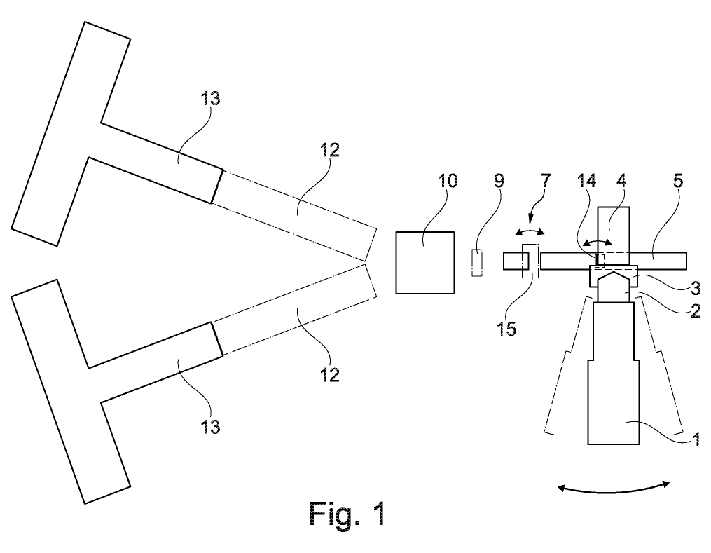

FIG. 1 shows manufacturing components of a first exemplary embodiment of a manufacturing installation according to the invention for carcass band,

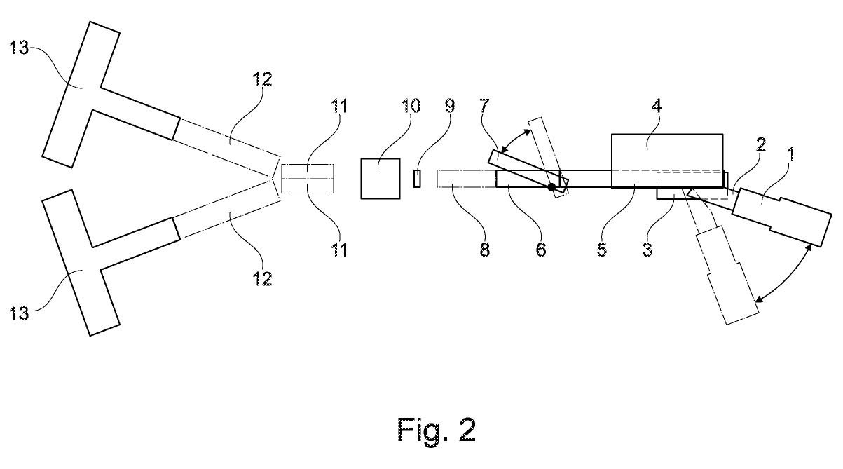

FIG. 2 shows manufacturing components of a second exemplary embodiment of a manufacturing installation according to the invention for belt band,

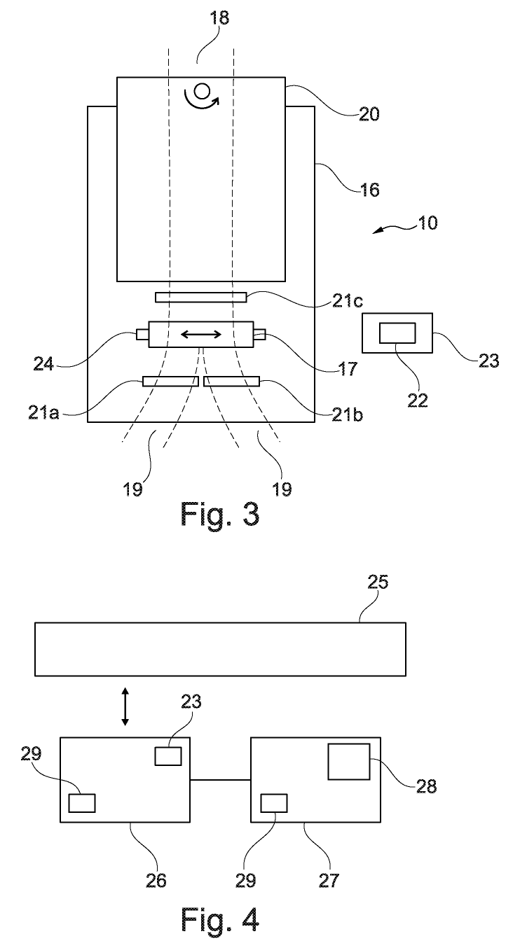

FIG. 3 shows a basic sketch of a slitter as a manufacturing component of the manufacturing installation,

FIG. 4 shows control and operating components for the first and second exemplary embodiment,

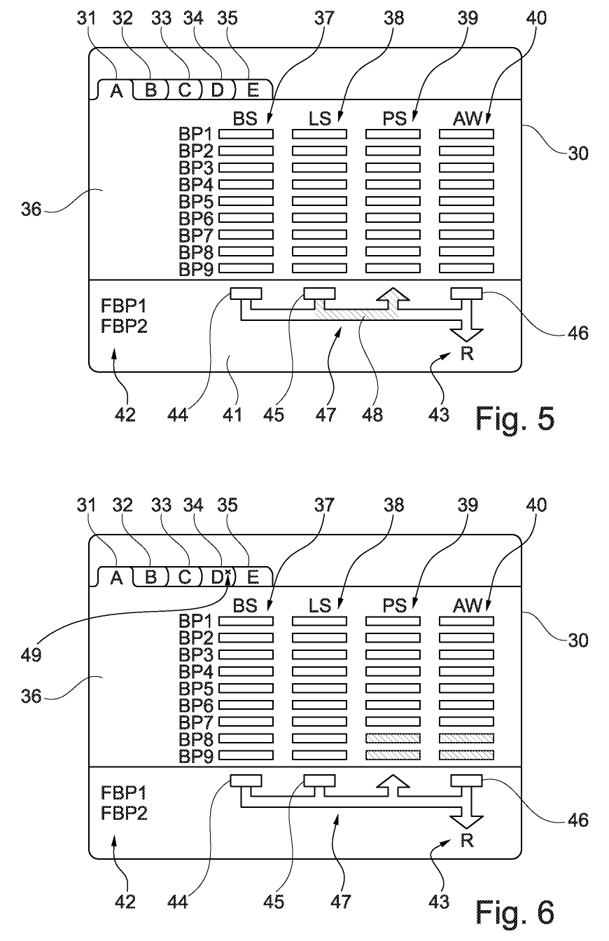

FIG. 5 shows an operating parameter display in a first operating situation,

FIG. 6 shows an operating parameter display in a second operating situation,

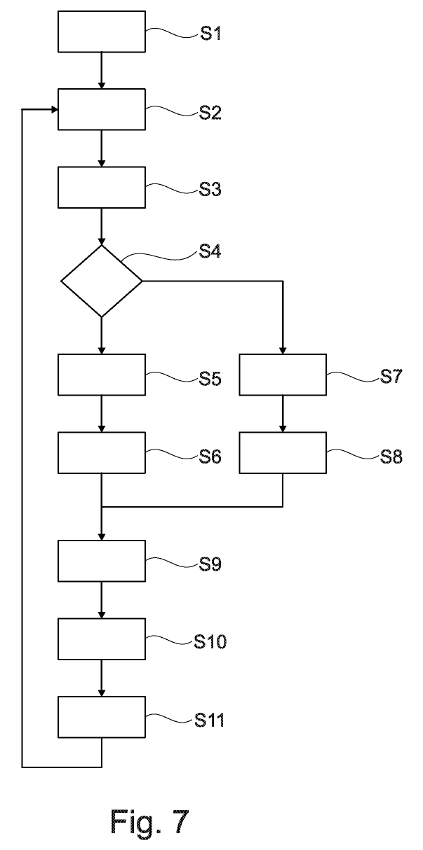

FIG. 7 shows a flowchart of one exemplary embodiment of the method according to the invention,

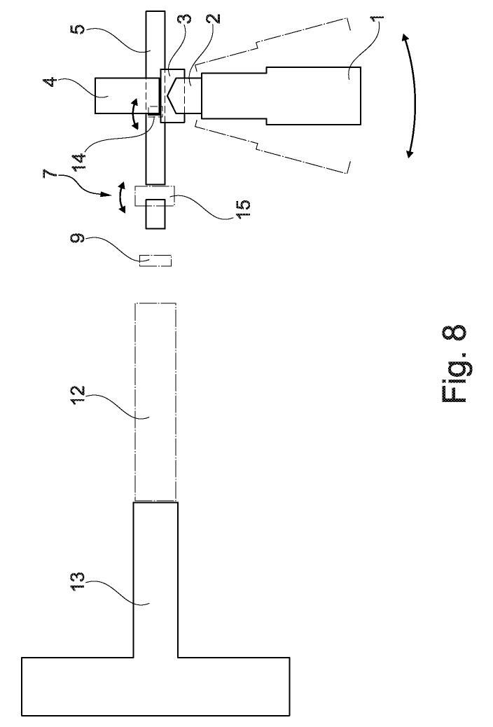

FIG. 8 shows manufacturing components of a third exemplary embodiment of a manufacturing installation according to the invention for carcass band, and

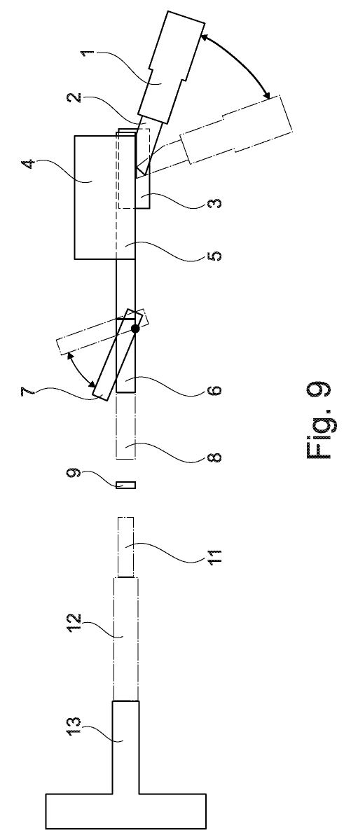

FIG. 9 shows manufacturing components of a fourth exemplary embodiment of a manufacturing installation according to the invention for belt band.

### DETAILED DESCRIPTION OF THE INVENTION

FIG. 1 shows an exemplary layout of a carcass installation having a slitter as a first exemplary embodiment of a manufacturing installation according to the invention.

The carcass installation comprises an unwinding station 1 from which the cord band to be processed is taken as a starting band. In the unwinding station 1, the material rolls to be processed are hung in a suitable frame and unwound. In this case, the cord web to be processed is separated from an intermediate layer (foil, linen or the like). This intermediate layer is used to prevent the material web, which is rubberized here, from sticking. To realize different cutting angles, the unwinding station 1 may be swiveled as explained, but this is not absolutely necessary. There are various embodiments with regard to such an unwinder. Single unwinders, in which a material roll is able to be hung, are known. In a double unwinder with a turntable, two material rolls are provided for hanging, one of which is processed, one of which is changed. In addition, a double unwinder with a shuttle frame for hanging two material rolls, one of which is processed, one of which is changed, is known. Furthermore, cassette unwinders, in which a material roll is hung in a cassette and the cassette is then transported into the unwinder, are known. This list is not exhaustive.

The swivelable unwinding station 1 is followed by a cutting device or scissors 3, which is used to cut the cord band coming from the unwinding station 1. The scissors 3 are used to cut cord band strips at a defined width and a defined angle. Various embodiments may be used as scissors 3:

Guillotine scissors with a fixed lower blade and an extendable/retractable upper blade,

Circular blade scissors with a fixed lower blade and a circular blade running along it, and

Scissors with a fast-rotating saw blade (similar to a circular saw blade).

Depending on the material to be processed, different scissor embodiments are used. The decisive factor here is which cord material (whether textile or steel cord) has to be cut and at what angle (carcass or belt installation types), wherein, in this example, scissors 3 are used for a carcass installation.

The material support 2 is connected to the unwinding station 1. If necessary, it swivels together therewith. The material to be processed lies on the material support 2 and is pulled, lying thereon, into the scissors 3. At the start of the material support 2 or above it, there is very often a conveying device that transports the start of the material into the scissors, for example a driven conveyor roller. This is necessary whenever the manufacturing installation is completely emptied and the start of a new material roll has to be inserted into the scissors 3, or if the material has been pulled back slightly from the scissors 3 in order to swivel the unwinding station 1.

The process after cutting is particularly relevant to the design of the scissors. In order to incorporate the cut material, that is to say the band sections, into the subsequent process with few processing steps, additional manufacturing components, such as for example belts and retainers, are used. These further manufacturing components should be located as close as possible to the scissors 3 (which likewise form manufacturing components). For this purpose, the material should be moved as little as possible (in particular in terms of a drop height) in order to process it further in a cut set-down position.

In order to convey the material through the scissors 3, a retraction device 4 is used as a manufacturing component in most cases. By way of example, a gripping apparatus (pliers) must be used to move very close to the bottom blade. This requires a certain amount of space in order to avoid collisions with the upper blade (or circular blade). This results in different designs of the scissors 3.

The retraction device 4 is used to convey the material web into the scissors 3, or pulls the gripped cord band through the scissors 3, as described above. The scissors 3 furthermore have a transport belt that receives the cut cord band section and transports it out of the scissors 3. Such a conveyor may be in the form of a single conveyor belt, in the form of multiple conveyor belts or in the form of multiple conveyor belts with an interposed lifting device.

The cord band section is then passed on to a first conveying device in the form of a belt 5 of a splicing device 7, here an overlap splicer 14, and supplied to the actual splicing unit. This first conveying device 5 may in principle also coincide with the conveying device that is assigned to the scissors 3, such that only one conveying device, which is then the first conveying device with respect to the overlap splicer 14, is located between the actual overlap splicer 14 and the scissors 3. The overlap splicer 14 is used to connect (purely mechanically, without the use of additives) the previously cut band sections. It may be swiveled at an angle in order to be able to process the band material at different angles.

Optionally, a further splicing apparatus in the form of a butt splicer 15 is also provided as part of the splicing device 7, which may be used in place of the overlap splicer 14, if this type of splicing is required.

A steadying roller 9, to be provided optionally, is arranged downstream of the overlap splicer 14 or its second conveying device (or the alternative butt splicer 15). This is merely a driven roller that transports the spliced-together cord band coming from the splicing device 7 to the next manufacturing component. In this case, the spliced-together cord band is counter-bent as a result of being transported through the steadying roller 9. The counter-bend causes the material to contract in the longitudinal direction. The background is thus to reduce the elongation of the material in the longitudinal direction during processing in the splicing device 7 according to the invention. During removal, the next band section is already cut in the scissors 3.

A slitter 10 is then provided as a further manufacturing component downstream of the (optional) steadying roller 9, which slitter will be explained in more detail with reference to FIG. 3. It should also be noted here that slitters 10 are used less frequently in carcass installations, but this does not rule out use thereof.

According to FIG. 1, the slitter 10 is followed by two covering apparatuses 12, which are likewise optional. In this manufacturing component, additional rubber strips, for example one to twelve pieces, are applied to the produced material web, that is to say the slitted cord band strips. The application may be carried out from above and/or from below. Furthermore, the outer edges of the material web are often edged, that is to say a rubber strip is applied from the outer edge without or with an overhang and laid around the rubber edge in order to cover the cord threads exposed at the outer edge, which corresponds to the cutting edge.

In any case, two winding stations 13 are provided. In these manufacturing components, the slitted cord band strips are wound back onto spools with an intermediate layer that prevents sticking. In this case too, there are various embodiments, ranging from fairly simple single winders, in which the material has to be cut manually and wound on a new roll, to fully automatic winders, in which no operator intervention whatsoever is necessary for material handling.

FIG. 2 shows an exemplary layout of a belt installation having a slitter as a second exemplary embodiment of a manufacturing installation according to the invention. Manufacturing components that have already been described in the layout of FIG. 1, where provided, have been provided with the same reference signs, and their function is the same as described in FIG. 1.

Provision is made for an unwinding station 1, which however, here, is able to be swiveled by a significantly larger angle. The unwinder may be of any type, as already described above.

The unwinding station 1 is followed by the scissors 3. The material support 2 is connected to the unwinding station 1. If necessary, it swivels together therewith.

The scissors 3 are used to cut cord band strips at a defined width and a defined angle. The types of scissors described above may be used as scissors 3, provided they are suitable for belt installations.

The scissors 3 are followed by a retraction device 4, as described above. This is used to convey the material web into the scissors 3, or pulls the gripped starting band through the scissors 3, as described above.

The cord band section is then passed on to the first conveying device (in the form of a belt 5) of a splicing device 7, which may comprise an overlap splicer or butt splicer, and supplied to the corresponding actual splicing apparatus. The splicing apparatus is able to be swiveled by a considerable angle in order to set the required splicing angle. It furthermore has a removal belt 6 as a conveying device, using which the spliced-together cord band is supplied to the downstream manufacturing component.

A belt 8 for manual splicing, that is to say for manual connection of the band sections, may optionally be connected downstream of the splicing device 7. During this manual processing, the automatic splicing device 7 is out of service. Such manual splicing is required for certain cord band materials, very narrow section widths or at the request of a customer. Optionally, a steadying roller 9 may also be provided in the second exemplary embodiment.

A slitter 10 follows as a further manufacturing component. The separation of the spliced material web achieved using the slitter 10 leads to two winding stations 13 having to be provided in any case, and a covering apparatus 12 and/or a repair belt 11 may each optionally be connected upstream of each thereof. If faults are detected in the band, they may be repaired here.

Although the cord band is conveyed from right to left in this illustration and also those that follow, it is of course possible to design the layout with a reverse, mirrored design, that is to say to transport the cord band from left to right. All manufacturing components described as optional may be provided in different combinations together with the essential manufacturing components. For this reason, different layouts may be created from all the manufacturing components described.

FIG. 3 shows, purely schematically, components of a slitter 10, as may be used in the layouts of FIGS. 1 and 2. A cutting unit 17 is arranged on a frame 16 and serves to separate the supplied spliced-together cord band 18 into at least two cord band strips 19. Normally, two interacting circular blades are provided for this purpose. Provision is furthermore made for a control frame 20 able to be swiveled relative to the frame 16 about a vertical swivel axis. The cord belt 18 runs over the control frame 20. From the control frame 20, it reaches the region of the cutting unit 17, where it is divided into the two cord band strips 19, as may be seen in the basic illustration according to FIG. 3.

To measure the width of the two cord band strips 19, the slitter 10 here has two width sensors 21a, 21b, one for each cord band strip 19. In other exemplary embodiments, provision may also be made for an arrangement of the width sensors 21a, 21b in the infeed area of a downstream manufacturing component, for example a covering apparatus 12. The width sensors 21a, 21b are able to completely detect the position of edges of the cord band strips 19, or the cord band strips 19. A further width sensor or edge sensor 21c is able to measure the width and position of the spliced-together cord band 18.

The sensor data from the width sensors 21a, 21b and possibly 21c here enter a closed control loop 22, which is realized by a closed-loop control device 23 assigned to the slitter 10, which is in this case associated with a control device of the manufacturing installation that is still to be discussed. In the control loop 22, measured variables are determined from the sensor data, from which measured variables it is possible to determine manipulated variables with regard to the swiveling of the control frame 20 about the vertically running axis and/or the transverse position of the cutting unit 17. In order to be able to adjust the cutting unit 17 transversely, it is arranged on the frame 16 so as to be linearly movable in a direction perpendicular to the conveying direction of the spliced-together cord band 18 via a linear guide 24. The alignment angle of the control frame 20 and the transverse position of the cutting unit 17 are also operating parameters that are settable within a certain recipe, here by way of the closed-loop control.

A more specific, more precise design of the slitter 10 is described by way of example in abovementioned DE 20 2013 104 651 U1.

The control loop 22 is one example of one of many closed control loops provided in the manufacturing installation that target an optimization objective and – in the case of at least substantially constant manufacturing conditions – usually end in an at least quasi-static state, that is to say in particular an optimum. The closed-loop control process may therefore be understood as an automatic learning process. The optimization objective in this case is to produce cord band strips 19 of constant, identical, predefined width.

Another example of such a control loop may be provided in the covering apparatus 12 for applying at least one rubberized band to the cord band (or in this case the cord band strips 19). The covering apparatus 12 may have a conveyor device for the cord belt 19 and a second conveyor device for the band to be applied and an application apparatus used to apply the band to the cord band 19, both of which are fed towards one another at approximately the same speed. The band to be applied may in this case be placed on the cord band 19 without pressure by the application apparatus. A pressure roller downstream of the application apparatus in the conveying direction of the covered cord band 19 and extending perpendicular to the conveying direction is spaced from a conveying device conveying the covered cord band by a gap, wherein the gap is smaller than the total thickness of cord band 19 and applied band. Such an embodiment is known for example from DE 20 2014 101 731 U1 already mentioned at the outset, wherein the exemplary embodiments described therein for manufacturing installations are also applicable here.

A closed control loop, again realized by a corresponding closed-loop control device of the control device, relates here for example to material strip closed-loop control, in which the band to be applied is able to be measured by an optical detection device, in particular a band edge detector, in order to determine at least one measured variable, and the control variable relates to a transverse position of the application apparatus, which is able to be adjusted perpendicular to the conveying direction by way of an adjustment unit.

Other closed-loop control operations may relate for example to the cutting angle at the scissors 3, the splice angle or other splicing properties at the splicing device 7 and the like.

FIG. 4 schematically shows the control, operating and monitoring structure of the manufacturing installation, that is to say in particular the belt installation or the carcass installation. In addition to the arrangement 25 of manufacturing components, the manufacturing installation has a control device 26, which in this case comprises the closed-loop control device 23 and possibly further closed-loop control devices. The operation of the manufacturing components of the arrangement 25 is able to be controlled by the control device 26. The control device 26 is also connected to an operating device 27, via which user inputs made by an operator are able to be received. The operating device 27 also has an output means 28, here a display or screen. It should be noted that a user interface may also be provided via Internet access or the like.

The control device 26 and/or the operating device 27 furthermore comprises a storage means 29, in which, in addition to other information, operating parameters (or specifically their values) may also be stored here. In this respect, it should first be noted that a manufacturing process for the production of a specific manufacturing product is usually based on what is known as a recipe, which comprises default parameters describing the manufacturing product (for example cutting angle of the scissors 3, desired width) and possibly further operating parameters, for example an output to be achieved. The operating parameters described by the recipe of the current manufacturing process usually cannot be changed during the manufacturing process. By way of example, they may be entered on the operating device and/or read out from a data carrier and/or server.

However, as already mentioned, there are also settable operating parameters within the scope of a manufacturing process performed to implement a specific recipe, wherein base values, which result in acceptable quality and stable progress of the manufacturing process, of the settable operating parameters are stored, in the storage means 29, as at least one base set that is provided by the manufacturer and is in particular recipe-specific, and are able to be retrieved by the control device 26 by way of the operating device 27 or else automatically. Settable operating parameters may be adjusted automatically during operation by the control device 26, for example by way of closed-loop control operations, but also at least partially by the operator by way of the operating device 27. Changes to the operating parameters, for example starting from the base set for a recipe, are basically used to optimize the manufacturing process or the manufacturing product. Both manual adjustments and automatic adjustments may be understood to be a learning process, because the result of the learning process is used to work at least towards the desired optimum.

In order not to lose results of such learning processes, which may also be understood as experience, and also to continue to use them profitably, the control device 26 is furthermore designed to store, in the storage means 29, in addition to the at least one base set, at least one learning set of settable operating parameters that is determined in at least one learning process. Learning sets stored in this way may be selected for control purposes depending on at least one user input on the operating device 27 and/or automatically.

In this case, the control device 26 and its control mode are on a higher level, and thus cover all manufacturing components of the arrangement 25. At least one of the settable operating parameters concerns multiple or even all manufacturing components, for example a conveying speed of the band material through the arrangement 25.

In this case, base sets for various recipes, that is to say recipe-specific base sets, are provided. Accordingly, the learning sets may also be at least recipe-specific. The current recipe may at least partially define the manufacturing conditions. Especially in the case of manufacturing conditions that go beyond this, differences may also result in different optima for the settable operating parameters, for which reason provision is made for multiple learning sets for different manufacturing conditions also to be able to be stored in the storage means 29, in a manner assigned to a base set, that is to say in particular also to a recipe. Manufacturing conditions, where not specified by the recipe, may also be detected at least partially automatically by the control device 26, for example by way of a sensor. One example of this is temperature. However, detection or derivation from condition information provided by the user is also conceivable, for example with regard to the material used. The manufacturing conditions under which a learning set was determined and is stored are stored in the storage means 29 as a condition dataset assigned to the learning set.

By way of example, if a new manufacturing process is to be started, the current manufacturing conditions may be compared with the manufacturing conditions in the learning sets in order to obtain a comparison result. If there is a (sufficient) match with regard to an already stored learning set, this may be selected. Otherwise, it is conceivable for example to use the base set. In addition to reusing stored learning sets for subsequent manufacturing processes, it is also conceivable to use these as a reference during automatic monitoring of the manufacturing process by the control device. By way of example, a learning set whose manufacturing conditions best match the current manufacturing conditions may be selected for monitoring, such that its values for the settable operating parameters are able to be compared with the current values for the settable operating parameters in order to determine deviation information. This deviation information may be evaluated, in particular through measure conditions, to each of which at least one measure is assigned. Such measures may concern outputting a warning and/or alarm, scheduling predictive maintenance, and/or providing highlighting for monitoring operators. It is also conceivable, as a measure, to store the current values of the settable operating parameters as a learning set, either as a replacement or update for a learning set of the same manufacturing conditions or as a new learning set for the current manufacturing conditions.

In the present case, however, monitoring by an operator and intuitive information feedback to an operator should also be provided, for which reason the output means 28 is used to output a user interface. With regard to the operating parameters and in particular the base set and the learning sets, the control device 26 may generate an operating parameter display for the user interface and output it thereon. The operating parameter display in this case shows the base set, at least one learning set and the currently set values of the operating parameters. The displayed learning set may in turn be the one whose assigned manufacturing conditions best match the current manufacturing conditions, for example based on the abovementioned comparison result. If a learning set has not yet been stored for a base set, in particular the current recipe, corresponding display fields may be left blank or else the values of the base set of the settable operating parameters may also be displayed there.

FIG. 5 schematically shows, by way of example, one possible operating parameter display 30 of the user interface in a first operating situation. In principle, the operating parameter display 30 in the present exemplary embodiment contains a plurality of tabs 31, 32, 33, 34, 35. Tab 31 is active and relates here to a partial display 36 containing general and/or important operating parameters. The other tabs 32, 33, 34, 35 relate to further partial displays and may be selected using the operating device 27. The other partial displays may for example be assigned to specific manufacturing components and/or manufacturing component groups or relate to specific subject areas. The further partial displays may also render detailed information, since for example the partial displays 36 may display values of a more abstract settable operating parameter, in relation to which values able to be derived therefrom of specific control parameters, which may also be settable operating parameters, may be contained in one of the further partial displays.

The boxes 37, 38, 39, 40 shown in the partial display 36 in FIG. 5 represent displayed values of settable operating parameters and may be understood to be display fields, wherein the boxes 37 relate to values of the base set (shown schematically in the figure as BS, possibly also “default values”), the boxes 38 relate to values of the learning set (shown schematically in the figure as LS, possibly also “stored values”), the boxes 39 relate to initial values, for example at the start of the manufacturing process (shown schematically in the figure as PS, possibly also “preset values”), and the boxes 40 relate to current values (shown schematically in the figure as “AW”, possibly “actual values” or “current values”).

A display area 41 may for example display fixed operating parameters that do not change during the manufacturing process or their values, cf. the schematically shown display elements 42, the current recipe, cf. the schematically shown display element 43, operating elements 44, 45, 46 and visualization elements 47. In this case, the operating element 44 is used here to generate a user input to use the base set, the operating element 45 is used to generate a user input to use the learning set, and the operating element 46 is used to generate a user input to store the current values of the settable operating parameters in the or a learning set to be assigned to the recipe. In this case, a user input does not necessarily have to be present in order to select values for operating parameters from base sets and learning sets and/or to store learning sets, but rather this may, in particular in an automatic mode still to be discussed, also be triggered by the control device 26 without user involvement.

This results in an operating situation in which the values of the settable operating parameters of the test set (boxes 38) are to be used as initial values (boxes 39). The appropriate selection of the test set may, as mentioned, have been made automatically or based on actuation of the operating element 45. The transfer process is visualized by highlighting, for example coloring, a corresponding portion of the visualization element 47, which is constantly greyed out. This results here in an arrow 48, for example a yellow arrow, becoming visible, cf. the hatching. This may also persist until new initial values are selected.

The fact that the operating parameter display 30 shows both the initial values and the current values of the settable operating parameters means that an operator is able to make comparisons, for example. However, this may also be supported by the control device 26 when deviations occur, as explained in more detail by FIG. 6, which shows the operating parameter display 30 in a second operating situation.

There, the current values deviate from the initial values in the case of two of the operating parameters displayed in the partial display 36. This is indicated to the operator for example by highlighting the correspondingly displayed values in color, cf. hatched boxes 39 and 40. It is also conceivable, as an alternative or in addition, to display deviations from the values (actually learned as being optimized) of the operating parameters according to the learning set.

In the case of FIG. 6, there are also deviations of the values of settable operating parameters that are not displayed in the partial display 36, but rather in another partial display, here in tab 34. To make the operator aware of this, tab 34 is highlighted, for example by displaying a corresponding symbol 49.

Generally speaking, the control device 26 is designed to be operated in multiple operating modes, wherein an operating mode to be used is able to be selected by way of the operating device 27. In the present case, the operating modes comprise at least an automatic operating mode in which the control device 26 automatically selects a learning set or base set and in particular also sets it automatically for use, thus controlling the manufacturing installation in accordance with the corresponding operating parameter set, and a manual mode in which the user input is used for selection and where applicable setting, but this may also result in the automatic use of the operating parameter set selected by the user input, that is to say the base set or one of the at least one learning set.

FIG. 7 shows a flowchart of one exemplary embodiment of the method according to the invention for operating a manufacturing installation according to the invention, as may be performed by the control device 26, wherein a distinction is drawn between the automatic mode and the manual mode at the appropriate points.

In step S1, a manufacturing process is started there, in this case for example initially one for which – at least for the given manufacturing conditions – no suitable learning set has yet been stored. A base set is therefore used as starting point. The recipe dataset, which contains the operating parameters or manufacturing conditions for the current recipe, is known and is logged in the storage means 29.

During the manufacturing process, as indicated by step S2, various automatic learning processes are performed by the control device 26, comprising the above-described closed-loop control operations, in particular the implementation of the control loop 22. This means that, in the latter case, the width of the cord band strip 19 is determined continuously by way of the width sensors 21a, 21b and compared with the setpoints or the correction value described above is determined. In the event of a closed-loop control deviation, a corresponding adjustment is made, in particular to the alignment angle of the control frame 20 and/or the transverse position of the cutting unit 17. Assuming that the manufacturing conditions do not change or change only very little, at some point an at least quasi-static state is reached, in which only changes within a tolerance range occur. The closed-loop control and any other closed-loop control operations and other automatic learning processes continue to be performed continuously until a recipe change is pending, that is to say the manufacturing process is terminated in favor of a new manufacturing process.

This then takes place in step S3. A recipe change may be triggered at the manufacturing installation itself, for example by an operator, or else by a higher-level customer connection.

In a step S4, a check is then carried out to determine whether the control device 26 is in automatic mode or in manual mode.

If manual mode is active, the operator is asked, in step S5, whether the current operating parameters of the manufacturing process that is now ending should be stored as a learning set. In the event of an appropriate user input, the control device 26 stores the new learning set in the storage means 29.

In addition, in manual mode, before the start of the new manufacturing process in step S6, the operator is asked which values should be used for the settable operating parameters. The operator may then for example select the base set or a stored learning set for the new recipe, or else only individual values of the operating parameters therefrom or operating parameters that they set themselves. Both step S5 and step S6 require appropriate know-how from the operator.

If automatic mode is present, the values for the operating parameters are left to be stored and loaded by the control device 26, which may be referred to as “Smart Parameter Management”. The control device 26 thus automatically decides, in a step S7 in the background, whether (and if so which) settable operating parameters should be stored. In this case, for example, in the case of closed control loops, a check may be carried out to determine whether the described quasi-static state was present. If there was already a learning set for the current manufacturing conditions, the control device 26 may carry out a check to determine whether there is a deviation that justifies an update. A change in manufacturing conditions compared to a pre-existing learning set, for example one used as a starting point, may also be checked in order to store a learning set assigned to the new manufacturing conditions.

In a step S8, the control device 26 automatically selects an operating parameter set to be used before the start of the new manufacturing process, for example, when learning sets are present, the one whose assigned manufacturing conditions best match the current manufacturing conditions or, in the case of an insufficient match or no learning set yet present, the base set. It should be noted that, in exemplary embodiments, a partial transfer of values of the settable operating parameters from a learning set is also conceivable, for example when settable operating parameters are assigned manufacturing conditions and/or a component-related comparison is carried out.

The new manufacturing process is then started in a step S9. By using results of previous learning processes, the changeover to the new recipe takes less time to produce high-quality products with less scrap.

Since test sets already exist for this recipe and may serve as a reference, in a step S10, the monitoring already described with regard to deviations takes place, for example in order to detect anomalies, to predictively trigger maintenance and the like. This monitoring may also result in learning sets being updated and/or stored again even during the ongoing manufacturing process, in particular in automatic mode.

In a step S11, the operating parameters are also visualized in the operating parameter display 30, possibly also depending on the results of step S10. This visualization is also available in automatic mode. Of course, the automatic learning processes, in particular closed-loop control operations, also continue to take place for the new recipe, for which reason step S2 is continuously performed until the end of the manufacturing process, in addition to steps S10 and S11.

It should be noted that other operating modes are also conceivable, for example those in which the user is asked to confirm operating parameter sets selected by the control device 26 or generally values for settable operating parameters and the like.

Specifically, the base sets and learning sets may be stored in the storage means 29, for example in an appropriate database, in particular an SQL database.

FIGS. 8 and 9 show further exemplary embodiments of manufacturing installations according to the invention for carcass band or belt band, respectively, operating without a slitter 10. Nevertheless, the control concept according to the invention may of course be applied accordingly. The reference signs are selected here for the same components as in FIGS. 1 and 2. The steadying roller 9, the covering apparatus 12 and the repair belt 11 are also optional in these exemplary embodiments.

It may be seen, in these cases, that in each case only one winding station 13 is provided due to the unused slitter 10.

While specific embodiments of the invention have been shown and described in detail to illustrate the inventive principles, it will be understood that the invention may be embodied otherwise without departing from such principles.

We claim:

1. A manufacturing installation for belt and/or carcass band in the tire industry, comprising multiple material-machining manufacturing components able to be controlled based on operating parameters, a control device for controlling the manufacturing components and an operating device, wherein the control device and/or the operating device has a storage means in which at least one fixed base set of settable operating parameters of the manufacturing components is stored, and is designed to select the base set for control purposes based on at least one user input on the operating device and/or automatically, wherein the control device is furthermore designed to store, in the storage means, in addition to the base set, at least one changeable learning set of settable operating parameters that is determined in a learning process and that is able to be selected for control purposes based on at least one user input on the operating device and/or automatically.

2. The manufacturing installation according to claim 1, wherein the control device is designed to determine the learning set at least partially in an automatic learning process.

3. The manufacturing installation according to claim 2, wherein the control device comprises a closed control loop for at least one controllable one of the operating parameters, wherein values of the at least one controllable operating parameter for the learning set are determined in an at least quasi-static state of the control loop from the set manipulated values of the at least one controllable operating parameter.

4. The manufacturing installation according to claim 1, wherein multiple base sets and learning sets for different manufacturing parameters, in particular recipes, are able to be stored in the storage means and/or the control device is designed to retain, in addition to a base set, multiple learning sets assigned to different manufacturing conditions in the storage means for selection.

5. The manufacturing installation according to claim 4, wherein the control device is designed to select one of the learning sets for current manufacturing conditions based on a comparison result of the manufacturing conditions of the learning sets with the current manufacturing conditions and/or in that the control device is designed, in the event of an in particular user-controlled change to the manufacturing conditions, in particular the selection of a new recipe at the start of a new manufacturing process, to store the current operating parameters as a learning set assigned to the previous manufacturing conditions.

6. The manufacturing installation according to claim 1, wherein, in the presence of one of the stored learning sets and settable current values for at least one variable one of the operating parameters that deviates from the learning set, in particular at least due to the control loop, the control device is designed to determine deviation information, indicating the deviation of the current values of the operating parameters from those of the learning set, and to evaluate the deviation information using at least one measure condition, wherein the control device is designed to perform a measure assigned to a fulfilled one of the at least one measure conditions.

7. The manufacturing installation according to claim 6, wherein at least one of the at least one measure concerns the output of a warning and/or alarm to an operator and/or the scheduling of predictive maintenance and/or at least one of the at least one measure concerns storage of the current values of the operating parameters as a learning set.

8. The manufacturing installation according to claim 1, wherein the operating device has an output means, in particular a display, for outputting a user interface, wherein the control device is designed to generate at least one operating parameter display on the user interface, in which the base set, the learning set and the currently set values of the operating parameters are displayed, and to control the output means so as to output the display.

9. The manufacturing installation according to claim 8, wherein the control device is designed to display each operating parameter whose current value deviates from the initial value of the operating parameter for the manufacturing process in highlighted form in the operating parameter display, in particular together with the initial value.

10. The manufacturing installation according to claim 1, wherein the manufacturing components comprise
an unwinding station for a starting band, in particular a cord band,
scissors for cutting band sections at a predefined angle and a predefined width from the starting band from the unwinding station,
a retraction device for conveying the starting band through the scissors,
a splicing device, in particular a butt splicer or an overlap splicer, for connecting the band sections cut by the scissors,
at least one winding station for the belt and/or carcass band, and
at least one conveying device.

11. The manufacturing installation according to claim 10, wherein the manufacturing components furthermore comprise a slitter and/or a covering apparatus.

12. The manufacturing installation according to claim 11, wherein, in the case of a slitter as a manufacturing component and the use of a closed control loop for the slitter, the manufacturing installation has at least one width sensor for determining the width of the slitted band strip, from the sensor data of which the control loop determines at least one of its measured variables.

13. The manufacturing installation according to claim 12, wherein the slitter has a frame, a cutting unit and a control frame able to swivel about an in particular vertically running axis and having guide rollers mounted rotationally thereon, via which the spliced-together endless band to be supplied to the cutting unit is guided, and the control loop is designed to use an operating parameter, which describes the alignment angle of the control frame of the slitter, and/or an operating parameter, which relates to the transverse position of the cutting unit, which is arranged on the frame so as to be linearly movable in a direction perpendicular to the conveying direction of the endless band via a linear guide, as manipulated variables.

14. The manufacturing installation according to claim 11, wherein, in the case of a covering apparatus for applying at least one rubberized band to the cord band as a manufacturing component, this has a conveying device for the cord band and a second conveying device for the band to be applied, and an application apparatus that is used to apply the band to the cord band, both of which are fed towards one another at approximately the same speed, and the band to be applied is able to be placed on the cord band without pressure by the application apparatus, wherein provision is made for a pressure roller downstream of the application apparatus in the conveying direction of the covered cord band and extending perpendicular to the conveying direction and spaced from the conveying device conveying the covered cord band by a gap, wherein the gap is smaller than the total thickness of cord band and applied band, and wherein the application apparatus is linearly adjustable in terms of its transverse position, which forms a settable operating parameter, with respect to the conveying direction.

15. The manufacturing installation according to claim 14, wherein, when using at least one closed control loop, one of these at least one control loops relates to material strip closed-loop control, in which the band to be applied is able to be measured by an optical detection device, in particular a band edge detector, in order to determine at least one measured variable, and the control variable relates to a transverse position of the application device, which is able to be adjusted perpendicular to the conveying direction by way of an adjustment unit.

16. A method for operating a manufacturing installation for belt and/or carcass band in tire production, comprising multiple material-machining manufacturing components able to be controlled based on operating parameters, a control device for controlling the manufacturing components and an operating device, wherein the control device and/or the operating device has a storage means in which at least one fixed base set of settable operating parameters of the manufacturing components is stored, and is designed to select the base dataset for control purposes based on at least one user input on the operating device and/or automatically, wherein the control device
stores, in the storage means, in addition to the base set, at least one changeable learning set of settable operating parameters that is determined in a learning process, and
selects at least one of the at least one learning set for control purposes based on at least one user input on the operating device and/or automatically.
